(19) United States
(12) Patent Application Publication
(10) Pub. No.: US 2020/0413421 A1
(43) Pub. Date: Dec. 31, 2020

(54) TECHNIQUES FOR CONFIGURING COMMUNICATION PERIODS FOR A MULTIPLE SUBSCRIBER IDENTIFICATION MODULE (MULTI-SIM) USER EQUIPMENT

(71) Applicant: QUALCOMM Incorporated, San Diego, CA (US)

(72) Inventors: Ozcan OZTURK, San Diego, CA (US); Reza SHAHIDI, San Diego, CA (US); Gavin Bernard HORN, La Jolla, CA (US)

(21) Appl. No.: 16/875,521

(22) Filed: May 15, 2020

Related U.S. Application Data
(60) Provisional application No. 62/867,540, filed on Jun. 27, 2019.

(51) Int. Cl. H04W 72/12; H04W 76/16

(52) U.S. Cl. CPC H04W 72/1215; H04W 88/06; H04W 76/16

(57) ABSTRACT

Various aspects of the present disclosure generally relate to wireless communication. In some aspects, a user equipment (UE) may establish a first access link associated with a first subscriber identification module (SIM) of the UE. The UE may establish a second access link associated with a second SIM of the UE. The UE may identify a set of time durations during which to use the second access link. The UE may transmit an indication of the set of time durations to a base station. The UE may tune to the second access link to communicate with the base station during at least one of the set of time durations. Numerous other aspects are provided.

### CROSS-REFERENCE TO RELATED APPLICATION

This Patent Application claims priority to U.S. Provisional Patent Application No. 62/867,540, filed on Jun. 27, 2019, entitled “TECHNIQUES FOR CONFIGURING COMMUNICATION PERIODS FOR A MULTIPLE SUBSCRIBER IDENTIFICATION MODULE (MULTI-SIM) USER EQUIPMENT,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques for configuring communication periods for a multiple subscriber identity module (multi-SIM) user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include establishing a first access link associated with a first subscriber identification module (SIM) of the UE; establishing a second access link associated with a second SIM of the UE; identifying a set of time durations during which to use the second access link; transmitting an indication of the set of time durations to a base station; and tuning to the second access link to communicate with the base station during at least one of the set of time durations.

In some aspects, a UE for wireless communication may include memory and one or more processors operatively coupled to the memory. The memory and the one or more processors may be configured to establish a first access link associated with a first SIM of the UE; establish a second access link associated with a second SIM of the UE; identify a set of time durations during which to use the second access link; transmit an indication of the set of time durations to a base station; and tune to the second access link to communicate with the base station during at least one of the set of time durations.

In some aspects, a non-transitory computer-readable medium may store one or more instructions for wireless communication. The one or more instructions, when executed by one or more processors of a UE, may cause the one or more processors to establish a first access link associated with a first SIM of the UE; establish a second access link associated with a second SIM of the UE; identify a set of time durations during which to use the second access link; transmit an indication of the set of time durations to a base station; and tune to the second access link to communicate with the base station during at least one of the set of time durations.

In some aspects, an apparatus for wireless communication may include means for establishing a first access link associated with a first SIM of the apparatus; means for establishing a second access link associated with a second SIM of the apparatus; means for identifying a set of time durations during which to use the second access link; means for transmitting an indication of the set of time durations to a base station; and means for tuning to the second access link to communicate with the base station during at least one of the set of time durations.

In some aspects, the indication of the set of time durations includes information identifying a pattern of the set of time durations. In some aspects, the pattern is a periodic pattern. In some aspects, the pattern is an aperiodic pattern. In some aspects, the pattern is a semi-persistent pattern. In some aspects, the pattern is controlled via at least one of media access control signaling, physical layer signaling, or radio resource control signaling.

In some aspects, the indication of the set of time durations is a request for configuration of the set of time durations, and the set of time durations are configured by at least one of a master node, a secondary node, or a combination thereof. In some aspects, tuning to the second access link further includes receiving data or control information from the base station. In some aspects, tuning to the second access link further includes transmitting data or control information to the base station. In some aspects, the indication of the set of time durations includes an index value identifying the set of time durations.

In some aspects, the set of time durations is configured to start based at least in part on received signaling, and the received signaling is at least one of radio resource control signaling, media access control layer signaling, or physical layer signaling. In some aspects, the method includes transmitting signaling to request an end to the set of time durations, and tuning to the first access link to communicate with the base station after ending the set of time durations. In some aspects, transmitting the signaling to request the end to the set of time durations includes starting a voice call or a data communication, and transmitting the signaling to request the end to the set of time durations based at least in part on starting the voice call or the data communication. In some aspects, the method includes transmitting signaling to request a change to the set of time durations, and communicating using at least one of the first access link or the second access link after changing the set of time durations.

In some aspects, the signaling to request the change to the set of time durations is at least one of radio resource control signaling identifying a different set of time durations or media access control layer signaling identifying an index of the different set of time durations. In some aspects, the set of time durations is for at least one of a downlink, an uplink, or a combination of the downlink and the uplink. In some aspects, tuning to the second access link includes reducing a communication capability on the first access link from a preconfigured communication capability, and communicating on the first access link in accordance with the reduced communication capability. In some aspects, the reduced communication capability is based at least in part on at least one of a band or radio access technology of: the second access link, the first access link, or a combination of the second access link and the first access link. In some aspects, the radio resource control signaling may be in-device coexistence indication signaling. In some aspects, at least one of the first SIM or the second SIM is a universal SIM (USIM).

Aspects generally include a method, apparatus, system, computer program product, non-transitory computer-readable medium, user equipment, base station, wireless communication device, and/or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3A is a block diagram conceptually illustrating an example of a frame structure in a wireless communication network, in accordance with various aspects of the present disclosure.

FIG. 3B is a block diagram conceptually illustrating an example synchronization communication hierarchy in a wireless communication network, in accordance with various aspects of the present disclosure.

FIG. 4 is a block diagram conceptually illustrating an example slot format with a normal cyclic prefix, in accordance with various aspects of the present disclosure.

FIG. 5 illustrates an example logical architecture of a distributed radio access network (RAN), in accordance with various aspects of the present disclosure.

FIG. 6 illustrates an example physical architecture of a distributed RAN, in accordance with various aspects of the present disclosure.

FIG. 7 is a diagram illustrating an example of configuring communication durations for a multiple subscriber identification module user equipment, in accordance with various aspects of the present disclosure.

FIG. 8 is a diagram illustrating an example process performed, for example, by a user equipment, in accordance with various aspects of the present disclosure.

FIG. 9 is conceptual data flow diagram illustrating a data flow between different modules/means/components in an example apparatus, in accordance with various aspects of the present disclosure.

FIG. 10 is conceptual data flow diagram illustrating a data flow between different modules/means/components in an example apparatus, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

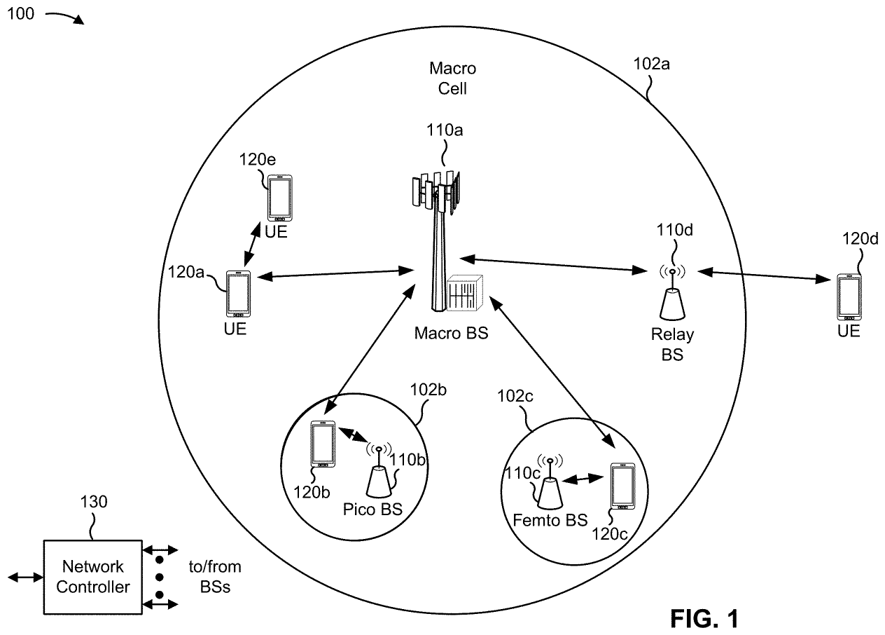

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

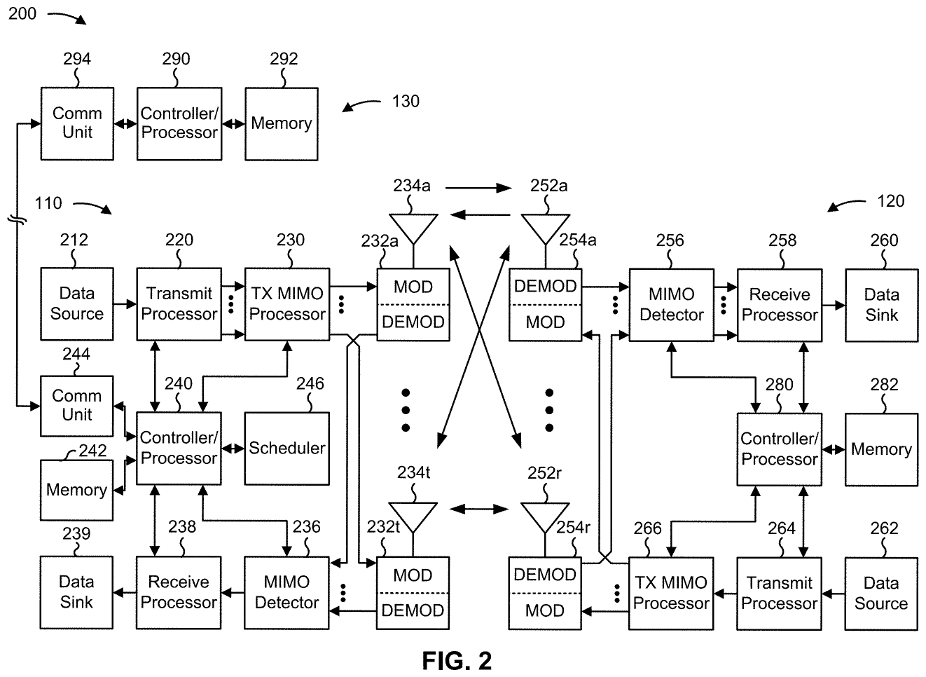

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

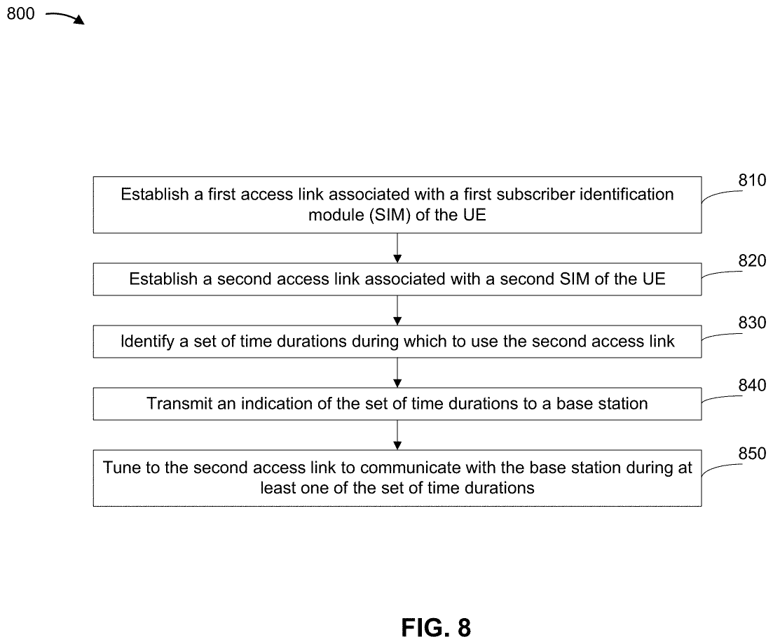

Controller/processor 240 of base station 110, controller/processor 280 of UE 120, and/or any other component(s) of FIG. 2 may perform one or more techniques associated with configuring communication periods for a multiple subscriber identification module (multi-SIM) UE, as described in more detail elsewhere herein. For example, controller/processor 240 of base station 110, controller/processor 280 of UE 120, and/or any other component(s) of FIG. 2 may perform or direct operations of, for example, process 800 of FIG. 8 and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direction operations of, for example, process 800 of FIG. 8 and/or other processes as described herein. A scheduler 246 may schedule UEs for data transmission on the downlink and/or uplink.

In some aspects, UE 120 may include means for establishing a first access link associated with a first SIM of UE 120, means for establishing a second access link associated with a second SIM of UE 120, means for identifying a set of time durations during which to use the second access link, means for transmitting an indication of the set of time durations to a base station, means for tuning to the second access link to communicate with the base station during at least one of the set of time durations, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

As indicated above, FIG. 2 is provided as an example. Other examples may differ from what is described with regard to FIG. 2.

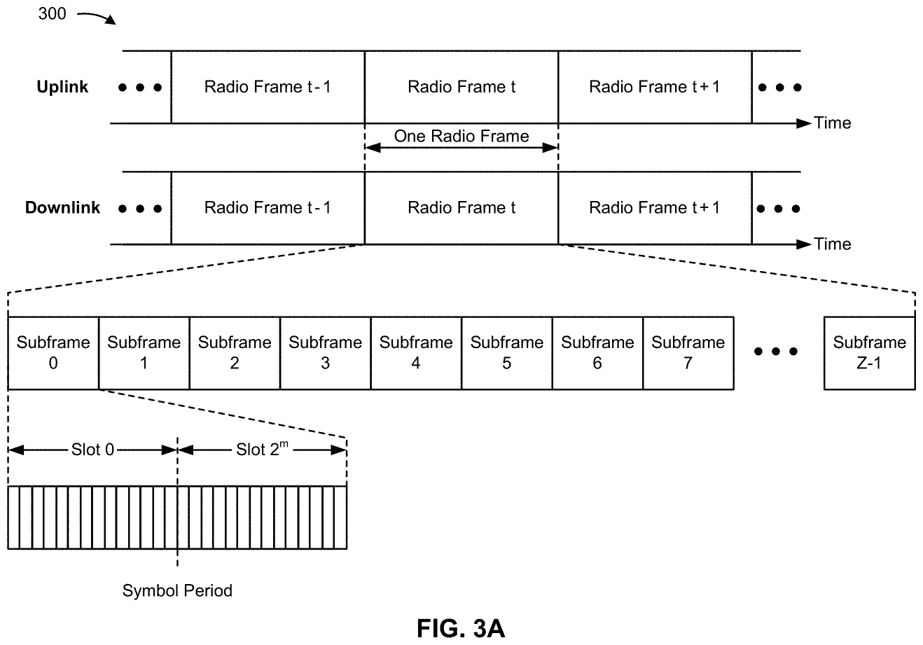

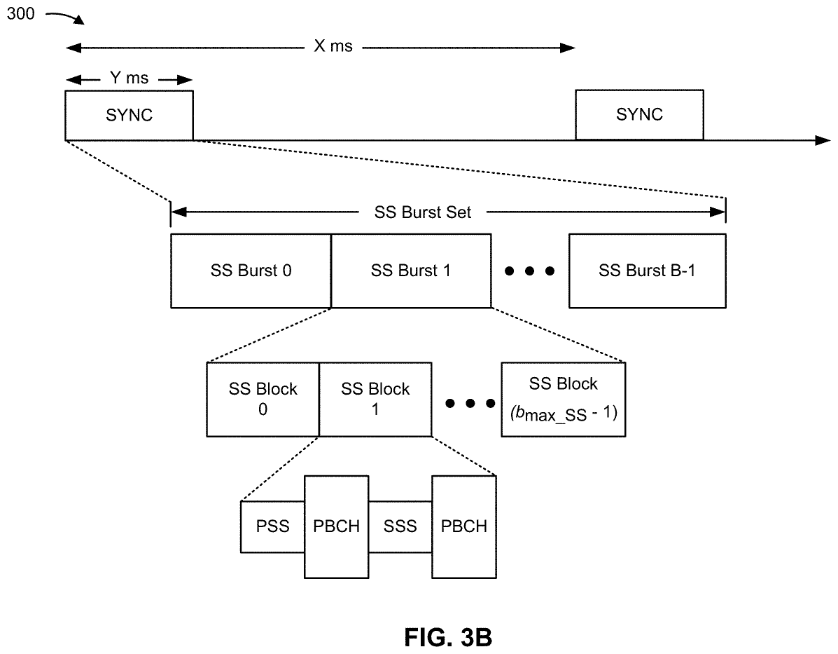

FIG. 3A shows an example frame structure 300 for frequency division duplexing (FDD) in a telecommunications system (e.g., NR). The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z-1). Each subframe may have a predetermined duration (e.g., 1 ms) and may include a set of slots (e.g., 2^{m} slots per subframe are shown in FIG. 3A, where m is a numerology used for a transmission, such as 0, 1, 2, 3, 4, and/or the like). Each slot may include a set of L symbol periods. For example, each slot may include fourteen symbol periods (e.g., as shown in FIG. 3A), seven symbol periods, or another number of symbol periods. In a case where the subframe includes two slots (e.g., when m=1), the subframe may include 2L symbol periods, where the 2L symbol periods in each subframe may be assigned indices of 0 through 2L-1. In some aspects, a scheduling unit for the FDD may be frame-based, subframe-based, slot-based, symbol-based, and/or the like.

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, a wireless communication structure may refer to a periodic time-bounded communication unit defined by a wireless communication standard and/or protocol. Additionally, or alternatively, different configurations of wireless communication structures than those shown in FIG. 3A may be used.

In certain telecommunications (e.g., NR), a base station may transmit synchronization signals. For example, a base station may transmit a primary synchronization signal (PSS), a secondary synchronization signal (SSS), and/or the like, on the downlink for each cell supported by the base station. The PSS and SSS may be used by UEs for cell search and acquisition. For example, the PSS may be used by UEs to determine symbol timing, and the SSS may be used by UEs to determine a physical cell identifier, associated with the base station, and frame timing. The base station may also transmit a physical broadcast channel (PBCH). The PBCH may carry some system information, such as system information that supports initial access by UEs.

In some aspects, the base station may transmit the PSS, the SSS, and/or the PBCH in accordance with a synchronization communication hierarchy (e.g., a synchronization signal (SS) hierarchy) including multiple synchronization communications (e.g., SS blocks), as described below in connection with FIG. 3B.

FIG. 3B is a block diagram conceptually illustrating an example SS hierarchy, which is an example of a synchronization communication hierarchy. As shown in FIG. 3B, the SS hierarchy may include an SS burst set, which may include a plurality of SS bursts (identified as SS burst 0 through SS burst B-1, where B is a maximum number of repetitions of the SS burst that may be transmitted by the base station). As further shown, each SS burst may include one or more SS blocks (identified as SS block 0 through SS block (b_{max_SS}-1), where bmax SS-1 is a maximum number of SS blocks that can be carried by an SS burst). In some aspects, different SS blocks may be beam-formed differently. An SS burst set may be periodically transmitted by a wireless node, such as every X milliseconds, as shown in FIG. 3B. In some aspects, an SS burst set may have a fixed or dynamic length, shown as Y milliseconds in FIG. 3B.

The SS burst set shown in FIG. 3B is an example of a synchronization communication set, and other synchronization communication sets may be used in connection with the techniques described herein. Furthermore, the SS block shown in FIG. 3B is an example of a synchronization communication, and other synchronization communications may be used in connection with the techniques described herein.

In some aspects, an SS block includes resources that carry the PSS, the SSS, the PBCH, and/or other synchronization signals (e.g., a tertiary synchronization signal (TSS)) and/or synchronization channels. In some aspects, multiple SS blocks are included in an SS burst, and the PSS, the SSS, and/or the PBCH may be the same across each SS block of the SS burst. In some aspects, a single SS block may be included in an SS burst. In some aspects, the SS block may be at least four symbol periods in length, where each symbol carries one or more of the PSS (e.g., occupying one symbol), the SSS (e.g., occupying one symbol), and/or the PBCH (e.g., occupying two symbols).

In some aspects, the symbols of an SS block are consecutive, as shown in FIG. 3B. In some aspects, the symbols of an SS block are non-consecutive. Similarly, in some aspects, one or more SS blocks of the SS burst may be transmitted in consecutive radio resources (e.g., consecutive symbol periods) during one or more slots. Additionally, or alternatively, one or more SS blocks of the SS burst may be transmitted in non-consecutive radio resources.

In some aspects, the SS bursts may have a burst period, whereby the SS blocks of the SS burst are transmitted by the base station according to the burst period. In other words, the SS blocks may be repeated during each SS burst. In some aspects, the SS burst set may have a burst set periodicity, whereby the SS bursts of the SS burst set are transmitted by the base station according to the fixed burst set periodicity. In other words, the SS bursts may be repeated during each SS burst set.

The base station may transmit system information, such as system information blocks (SIBs) on a physical downlink shared channel (PDSCH) in certain slots. The base station may transmit control information/data on a physical downlink control channel (PDCCH) in C symbol periods of a slot, where B may be configurable for each slot. The base station may transmit traffic data and/or other data on the PDSCH in the remaining symbol periods of each slot.

As indicated above, FIGS. 3A and 3B are provided as examples. Other examples may differ from what is described with regard to FIGS. 3A and 3B.

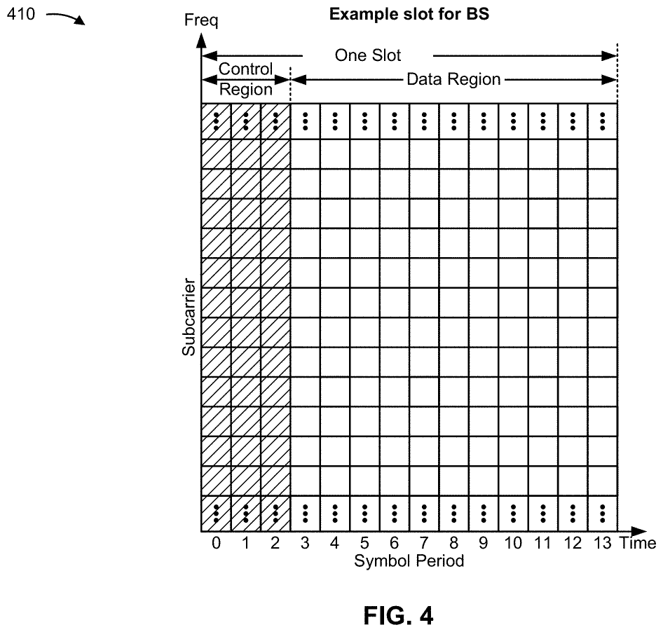

FIG. 4 shows an example slot format 410 with a normal cyclic prefix. The available time frequency resources may be partitioned into resource blocks. Each resource block may cover a set of subcarriers (e.g., 12 subcarriers) in one slot and may include a number of resource elements. Each resource element may cover one subcarrier in one symbol duration (e.g., in time) and may be used to send one modulation symbol, which may be a real or complex value.

An interlace structure may be used for each of the downlink and uplink for FDD in certain telecommunications systems (e.g., NR). For example, Q interlaces with indices of 0 through Q-1 may be defined, where Q may be equal to 4, 6, 8, 10, or some other value. Each interlace may include slots that are spaced apart by Q frames. In particular, interlace q may include slots q, q+Q, q+2Q, etc., where q ∈{0, . . . , Q-1}.

A UE may be located within the coverage of multiple BSs. One of these BSs may be selected to serve the UE. The serving BS may be selected based at least in part on various criteria such as received signal strength, received signal quality, path loss, and/or the like. Received signal quality may be quantified by a signal-to-noise-and-interference ratio (SNIR), or a reference signal received quality (RSRQ), or some other metric. The UE may operate in a dominant interference scenario in which the UE may observe high interference from one or more interfering BSs.

While aspects of the examples described herein may be associated with NR or 5G technologies, aspects of the present disclosure may be applicable to other wireless communication systems. New Radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). In aspects, NR may utilize OFDM with a CP (herein referred to as cyclic prefix OFDM or CP-OFDM) and/or SC-FDM on the uplink, may utilize CP-OFDM on the downlink and include support for half-duplex operation using time division duplexing (TDD). In aspects, NR may, for example, utilize OFDM with a CP (herein referred to as CP-OFDM) and/or discrete Fourier transform spread orthogonal frequency-division multiplexing (DFT-s-OFDM) on the uplink, may utilize CP-OFDM on the downlink and include support for half-duplex operation using TDD. NR may include Enhanced Mobile Broadband (eMBB) service targeting wide bandwidth (e.g., 80 megahertz (MHz) and beyond), millimeter wave (mmW) targeting high carrier frequency (e.g., 60 gigahertz (GHz)), massive MTC (mMTC) targeting non-backward compatible MTC techniques, and/or mission critical targeting ultra reliable low latency communications (URLLC) service.

In some aspects, a single component carrier bandwidth of 100 MHz may be supported. NR resource blocks may span 12 sub-carriers with a sub-carrier bandwidth of 60 or 120 kilohertz (kHz) over a 0.1 millisecond (ms) duration. Each radio frame may include 40 slots and may have a length of 10 ms. Consequently, each slot may have a length of 0.25 ms. Each slot may indicate a link direction (e.g., DL or UL) for data transmission and the link direction for each slot may be dynamically switched. Each slot may include DL/UL data as well as DL/UL control data.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface. NR networks may include entities such as central units or distributed units.

As indicated above, FIG. 4 is provided as an example. Other examples may differ from what is described with regard to FIG. 4.

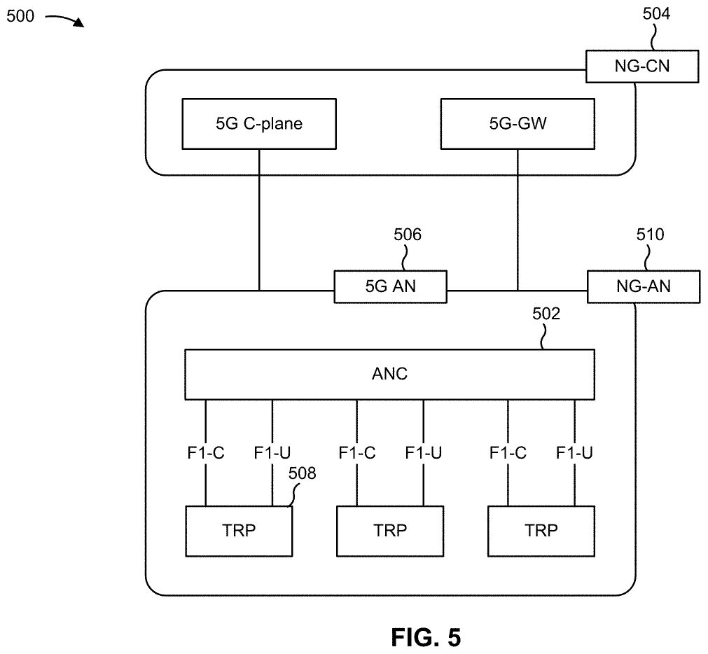

FIG. 5 illustrates an example logical architecture of a distributed RAN 500, according to aspects of the present disclosure. A 5G access node 506 may include an access node controller (ANC) 502. The ANC may be a central unit (CU) of the distributed RAN 500. The backhaul interface to the next generation core network (NG-CN) 504 may terminate at the ANC. The backhaul interface to neighboring next generation access nodes (NG-ANs) may terminate at the ANC. The ANC may include one or more TRPs 508 (which may also be referred to as BSs, NR BSs, Node Bs, 5G NBs, APs, gNBs, or some other term). As described above, a TRP may be used interchangeably with “cell.”

The TRPs 508 may be a distributed unit (DU). The TRPs may be connected to one ANC (ANC 502) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of RAN 500 may be used to illustrate fronthaul definition. The architecture may be defined that support fronthauling solutions across different deployment types. For example, the architecture may be based at least in part on transmit network capabilities (e.g., bandwidth, latency, and/or jitter).

The architecture may share features and/or components with LTE. According to aspects, the next generation AN (NG-AN) 510 may support dual connectivity with NR. The NG-AN may share a common fronthaul for LTE and NR.

The architecture may enable cooperation between and among TRPs 508. For example, cooperation may be preset within a TRP and/or across TRPs via the ANC 502. According to aspects, no inter-TRP interface may be needed/present.

According to aspects, a dynamic configuration of split logical functions may be present within the architecture of RAN 500. The packet data convergence protocol (PDCP), radio link control (RLC), media access control (MAC) protocol may be adaptably placed at the ANC or TRP.

According to various aspects, a BS may include a central unit (CU) (e.g., ANC 502) and/or one or more distributed units (e.g., one or more TRPs 508).

As indicated above, FIG. 5 is provided as an example. Other examples may differ from what is described with regard to FIG. 5.

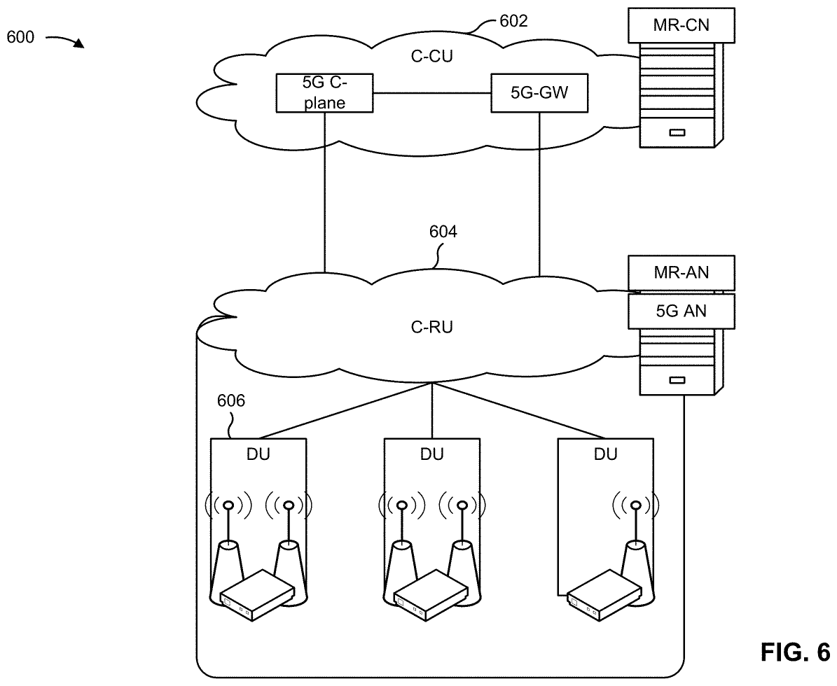

FIG. 6 illustrates an example physical architecture of a distributed RAN 600, according to aspects of the present disclosure. A centralized core network unit (C-CU) 602 may host core network functions. The C-CU may be centrally deployed. C-CU functionality may be offloaded (e.g., to advanced wireless services (AWS)), in an effort to handle peak capacity.

A centralized RAN unit (C-RU) 604 may host one or more ANC functions. Optionally, the C-RU may host core network functions locally. The C-RU may have distributed deployment. The C-RU may be closer to the network edge.

A distributed unit (DU) 606 may host one or more TRPs. The DU may be located at edges of the network with radio frequency (RF) functionality.

As indicated above, FIG. 6 is provided as an example. Other examples may differ from what is described with regard to FIG. 6.

In some communication systems, such as NR with concurrent radio access technology (C-RAT)-enabled UEs, a multi-SIM UE may connect to a BS using a plurality of access links. For example, the UE may establish a first access link with a BS using a first SIM of the UE (e.g., a universal SIM (USIM)) and a second access link with the BS (or with another BS) using a second SIM of the UE (e.g., a USIM). The UE may receive data and/or signaling from the BS(s) and/or may transmit data and/or signaling to the BS(s).

However, in some cases, the UE may not be capable of receiving data and/or signaling on a plurality of access links using a plurality of SIMs at a single time. For example, a processing capability of the UE may prevent the UE from concurrently receiving using a first SIM on a first access link and a second SIM on a second access link. Similarly, receive and/or transmitting, concurrently, on a plurality of access links and using a plurality of SIMs may result in interference. Some aspects described herein enable configuration of one or more time durations during which to use one of a plurality of access links rather than both of the plurality of access links. For example, the UE may identify a time duration for tuning from a first access link associated with a first SIM and to a second access link associated with a second SIM, and may tune to the second access link to, for example, receive signaling and/or data on the second access link. In this way, the UE reduces a likelihood of dropped communications resulting from attempting to concurrently transmit and/or receive a plurality of data transmissions or control signals on a plurality of access links using a plurality of SIMs.

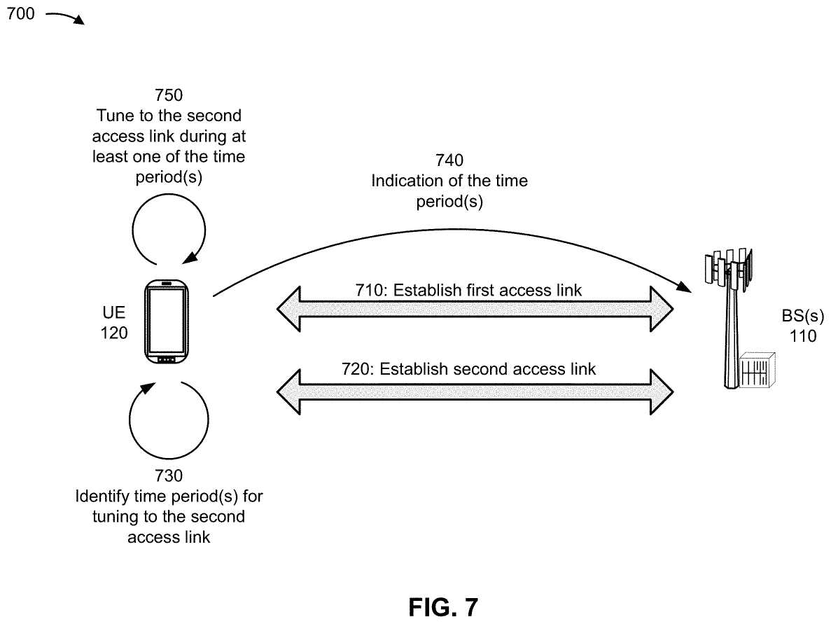

FIG. 7 is a diagram illustrating an example 700 of configuring communication periods for a multi-SIM UE, in accordance with various aspects of the present disclosure. As shown in FIG. 7, example 700 includes a BS 110 and a UE 120.

As further shown in FIG. 7, and by reference numbers 710 and 720, UE 120 may establish a plurality of access links with one or more BSs 110. For example, UE 120 may establish a first access link with a BS 110 using a first SIM of UE 120 and may establish a second access link with the BS 110 using a second SIM of UE 120. Additionally, or alternatively, UE 120 may establish the first access link with a first BS 110 (e.g., a master node) and a second link with a second BS 110 (e.g., a secondary node). Although some aspects are described herein in terms of two access links with a single BS or two access links with two BSs, various quantities and combinations of access links and/or BSs are contemplated.

As further shown in FIG. 7, and by reference number 730, UE 120 may identify one or more time durations for tuning to an access link. For example, UE 120 may identify a single time duration or a plurality of time durations for tuning to the second access link associated with the second SIM. In some aspects, UE 120 may identify one or more time durations for tuning to the second access link for downlink communication. Additionally, or alternatively, UE 120 may identify the one or more time durations for tuning to the second access link for uplink communication. Additionally, or alternatively, UE 120 may identify the one or more time durations for tuning to the second access link for a combination of downlink communication and uplink communication. In some aspects, the one or more time durations may be associated with a fixed gap. Additionally, or alternatively, the one or more time durations may be associated with a flexible gap that different for a first set of time durations then for a second set of time durations.

In some aspects, UE 120 may identify a pattern for tuning to the second access link associated with the second SIM. For example, UE 120 may determine to tune to the second access link with a periodicity or according to a plurality of different periodicities. In this case, the time durations may be periodic according to the periodicity or the plurality of different periodicities. For example, UE 120 may schedule periodic time durations to enable UE 120 to receive paging messages, system information messages, and/or the like on the second access link. Additionally, or alternatively, UE 120 may schedule the periodic time durations to enable periodic transmissions, such as tracking area update (TAU) transmissions, RAN-based notification area update (RNAU) transmissions, and/or the like.

Additionally, or alternatively, the time durations may be aperiodic. For example, UE 120 may determine to tune to the second access link at a time rather than according to a periodicity. In this case, UE 120 may use an aperiodic time duration for transmitting and/or receive an aperiodic communication, such as a mobility-triggered TAU message or RNAU message. Additionally, or alternatively, the time durations may be semi-persistent. For example, UE 120 may determine to tune to the second access link for a plurality of time durations and/or for a duration that may be controlled via semi-persistent signaling. In this case, UE 120 may receive first signaling to start a plurality of semi-persistently scheduled time durations and may subsequently receive second signaling to stop the plurality of semi-persistently scheduled time durations. In some aspects, the first signaling to start and/or the second signaling to stop the semi-persistently scheduled time durations may be media access control (MAC) layer signaling (e.g., a MAC control element (CE)), radio resource control (RRC) signaling, physical (PHY) layer signaling (e.g., a downlink control information (DCI) message), and/or the like.

In some aspects, UE 120 may identify the time durations based on received signaling from a BS 110. For example, UE 120 may transmit a message to request scheduling of time durations for tuning to the second access link, and BS 110 may transmit a response message identifying a pattern for the time durations (e.g., using MAC layer signaling, RRC signaling, PHY layer signaling, and/or the like). In some aspects, UE 120 may receive a configuration message from BS 110 including an index value corresponding to a pattern for the time durations. For example, UE 120 may store information (e.g., a table) identifying a plurality of candidate time durations, and may receive information identifying an index value for a candidate time duration of the plurality of candidate time durations. Additionally, or alternatively, UE 120 may receive information identifying when to start the time durations (e.g., an index value identifying a system frame number, a system time, and/or the like).

As further shown in FIG. 7, and by reference number 740, UE 120 may transmit information indicating the one or more time durations. For example, UE 120 may transmit a message to one or more BSs 110 to which UE 120 is connected using the plurality of access links to indicate that UE 120 is to tune to an access link during one or more time durations. In this case, BS 110 may be triggered to transmit data and/or signaling to UE 120 using, for example, the second access link during the one or more time durations, and to avoid transmitting data and/or signaling to UE 120 using, for example, the first access link during the one or more time durations. Additionally, or alternatively, when UE 120 is to reduce a communication capability on the first access link during the one or more time durations, BS 110 may be triggered to change a set of bands used to communicate, a band combination for communication, a RAT that is used, a data rate, a transmit power, and/or the like for the first access link during the time durations.

In some aspects, UE 120 may transmit information indicating the one or more time durations to one or more nodes in a multi-hop network or one or more nodes of a dual-connectivity scenario. For example, UE 120 may transmit information indicating the one or more time durations to a master node and a secondary node (e.g., which may be BSs 110). In this case, the master node and the secondary node may communicate to coordinate signaling in accordance with the one or more time durations and/or to schedule the one or more time durations for UE 120. For example, the master node may receive an indication that UE 120 is to receive signaling in accordance with a plurality of time durations for tuning to the second access link, and may communicate with the secondary node to identify a pattern of time durations for dual connectivity with UE 120. In this case, the master node may signal the pattern of time durations to UE 120 to enable UE 120 to tune to the second access link to receive signaling and/or data from the master node, the secondary node, and/or the like.

As further shown in FIG. 7, and by reference number 750, UE 120 may tune to an access link during at least one of the one or more time durations. For example, UE 120 may tune to the second access link during at least one of a plurality of time durations. In some aspects, UE 120 may stop tuning to the first access link during the at least one of the plurality of time durations. For example, UE 120 may tune to the second access link associated with the second SIM to receive data and/or signaling on the second access link, and may tune from the first access link associated with the first SIM to forgo receiving data and/or signaling on the first access link. Alternatively, UE 120 may continue tuning to the first access link during the at least one of the plurality of time durations, but may reduce a communication capability on the first access link. For example, UE 120 may change a set of bands used to communicate, a band combination for communication, a RAT that is used for communication, a data rate, a transmit power, and/or the like for the first access link during the at least one of the plurality of time durations. In this way, UE 120 may allocate additional processing resources to the second access link, avoid interference with the second access link, and/or the like.

In some aspects, at a subsequent time, UE 120 may request a change to a configuration of a plurality of time durations. For example, UE 120 may transmit RRC signaling, MAC layer signaling, PHY layer signaling, and/or the like to request a different pattern for the plurality of time durations. In this case, UE 120 may transmit information identifying an index value of a different candidate pattern for the plurality of time durations, information explicitly identifying a time for the plurality of time durations, and/or the like. Additionally, or alternatively, UE 120 may request an end to the plurality of time durations. For example, when UE 120 is to start a voice call, a high-priority data transmission, and/or the like, UE 120 may request that the plurality of time durations be ended, suspended, and/or the like.

As indicated above, FIG. 7 is provided as an example. Other examples may differ from what is described with respect to FIG. 7.

FIG. 8 is a diagram illustrating an example process 800 performed, for example, by a UE, in accordance with various aspects of the present disclosure. Example process 800 is an example where a UE (e.g., UE 120 and/or the like) performs operations associated with techniques for configuring communication periods for a multi-SIM UE.

As shown in FIG. 8, in some aspects, process 800 may include establishing a first access link associated with a first subscriber identification module (SIM) of the UE (block 810). For example, the UE (e.g., using receive processor 258, transmit processor 264, controller/processor 280, memory 282, and/or the like) may establish a first access link associated with a first SIM of the UE, as described above.

As further shown in FIG. 8, in some aspects, process 800 may include establishing a second access link associated with a second SIM of the UE (block 820). For example, the UE (e.g., using receive processor 258, transmit processor 264, controller/processor 280, memory 282, and/or the like) may establish a second access link associated with a second SIM of the UE, as described above.

As further shown in FIG. 8, in some aspects, process 800 may include identifying a set of time durations during which to use the second access link (block 830). For example, the UE (e.g., using receive processor 258, transmit processor 264, controller/processor 280, memory 282, and/or the like) may identify a set of time durations during which to use the second access link, as described above.

As further shown in FIG. 8, in some aspects, process 800 may include transmitting an indication of the set of time durations to a base station (block 840). For example, the UE (e.g., using receive processor 258, transmit processor 264, controller/processor 280, memory 282, and/or the like) may transmit an indication of the set of time durations to a base station, as described above.

As further shown in FIG. 8, in some aspects, process 800 may include tuning to the second access link to communicate with the base station during at least one of the set of time durations (block 850). For example, the UE (e.g., using receive processor 258, transmit processor 264, controller/processor 280, memory 282, and/or the like) may tune to the second access link to communicate with the base station during at least one of the set of time durations, as described above.

Process 800 may include additional aspects, such as any single aspect or any combination of aspects described below and/or in connection with one or more other processes described elsewhere herein.

In a first aspect, the indication of the set of time durations includes information identifying a pattern of the set of time durations.

In a second aspect, alone or in combination with the first aspect, the pattern is a periodic pattern.

In a third aspect, alone or in combination with one or more of the first and second aspects, the pattern is an aperiodic pattern.

In a fourth aspect, alone or in combination with one or more of the first through third aspects, the pattern is a semi-persistent pattern.

In a fifth aspect, alone or in combination with one or more of the first through fourth aspects, the pattern is controlled via at least one of media access control signaling, physical layer signaling, or radio resource control signaling.

In a sixth aspect, alone or in combination with one or more of the first through fifth aspects, the indication of the set of time durations is a request for configuration of the set of time durations, and the set of time durations are configured by at least one of a master node, a secondary node, or a combination thereof.

In a seventh aspect, alone or in combination with one or more of the first through sixth aspects, tuning to the second access link further includes receiving data or control information from the base station.

In an eighth aspect, alone or in combination with one or more of the first through seventh aspects, tuning to the second access link further includes transmitting data or control information to the base station.

In a ninth aspect, alone or in combination with one or more of the first through eighth aspects, the indication of the set of time durations includes an index value identifying the set of time durations.

In a tenth aspect, alone or in combination with one or more of the first through ninth aspects, the set of time durations is configured to start based at least in part on received signaling, and the received signaling is at least one of radio resource control signaling, media access control layer signaling, or physical layer signaling.

In an eleventh aspect, alone or in combination with one or more of the first through tenth aspects, process 800 includes transmitting signaling to request an end to the set of time durations, and tuning to the first access link to communicate with the base station after ending the set of time durations.

In a twelfth aspect, alone or in combination with one or more of the first through eleventh aspects, transmitting the signaling to request the end to the set of time durations includes starting a voice call or a data communication, and transmitting the signaling to request the end to the set of time durations based at least in part on starting the voice call or the data communication.

In a thirteenth aspect, alone or in combination with one or more of the first through twelfth aspects, process 800 includes transmitting signaling to request a change to the set of time durations, and communicating using at least one of the first access link or the second access link after changing the set of time durations.

In a fourteenth aspect, alone or in combination with one or more of the first through thirteenth aspects, the signaling to request the change to the set of time durations is at least one of radio resource control signaling identifying a different set of time durations or media access control layer signaling identifying an index of the different set of time durations.

In a fifteenth aspect, alone or in combination with one or more of the first through fourteenth aspects, the set of time durations is for at least one of a downlink, an uplink, or a combination of the downlink and the uplink.

In a sixteenth aspect, alone or in combination with one or more of the first through fifteenth aspects, tuning to the second access link includes reducing a communication capability on the first access link from a preconfigured communication capability, and communicating on the first access link in accordance with the reduced communication capability.

In a seventeenth aspect, alone or in combination with one or more of the first through sixteenth aspects, the reduced communication capability is based at least in part on at least one of a band or radio access technology of: the second access link, the first access link, or a combination of the second access link and the first access link.

In an eighteenth aspect, alone or in combination with one or more of the first through seventeenth aspects, the radio resource control signaling may be in-device coexistence indication signaling.

In a nineteenth aspect, alone or in combination with one or more of the first through eighteenth aspects, at least one of the first SIM or the second SIM is a universal SIM (USIM).

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

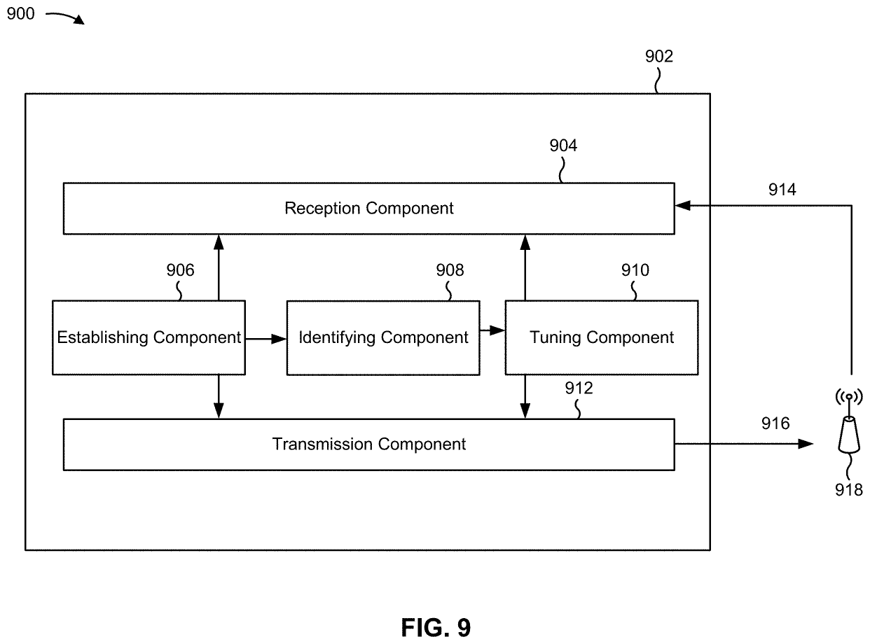

FIG. 9 is a conceptual data flow diagram 900 illustrating the data flow between different modules/means/components in an example apparatus 902. The apparatus 902 may be a user equipment (e.g., UE 120). In some aspects, apparatus 902 includes a reception component 904, an establishing component 906, an identifying component 908, a tuning component 910, and a transmission component 912.

Reception component 904 may receive a communication 914 from BS 918. For example, reception component 904 may receive communication 914 using a first access link established with BS 918, a second access link established with BS 918, and/or the like during a time duration for tuning to an access link established with BS 918. In some aspects, reception component 904 may receive communication 914, which may identify a pattern for time durations for tuning to the access link. In some aspects, reception component 904 may include an antenna (e.g., antenna 234), a receive processor (e.g., receive processor 238), a controller/processor (e.g., controller/processor 240), a transceiver, a receiver, and/or the like.

Establishing component 906 may establish access links with BS 918. For example, establishing component 906 may communicate with reception component 904 to establish a downlink access link, transmission component 912 to establish an uplink access link, and/or the like. In some aspects, establishing component 906 may include a processor (e.g., a transmit processor 220, a receive processor 238, a controller/processor 240, and/or the like).

Identifying component 908 may identify one or more time durations for tuning to an access link of a plurality of access links. For example, identifying component 908 may identify a pattern with which to tune to an access link to receive signaling and/or data, to transmit signaling and/or data, and/or the like. In some aspects, identifying component 908 may include a processor (e.g., a transmit processor 220, a receive processor 238, a controller/processor 240, and/or the like).

Tuning component 910 may tune the apparatus 902 to an access link, of a plurality of access links, associated with a SIM of a plurality of SIMs. For example, tuning component 910 may control reception component 904 to receive using the access link during a time duration. Additionally, or alternatively, tuning component 910 may control transmission component 912 to transmit using the access link during a time duration. In some aspects, tuning component 910 may include a processor (e.g., a transmit processor 220, a receive processor 238, a controller/processor 240, and/or the like).

Transmission component 912 may transmit a communication 916 to BS 918. For example, transmission component 912 may transmit communication 916 using a first access link established with BS 918, a second access link established with BS 918, and/or the like during a time duration for tuning to an access link established with BS 918. In some aspects, transmission component 912 may transmit communication 916 to request determination of time durations for tuning to an access link, to identify a pattern for the time durations for tuning to the access link, and/or the like. In some aspects, transmission component 912 may include an antenna (e.g., antenna 234), a transmit processor (e.g., transmit processor 220), a controller/processor (e.g., controller/processor 240), a transceiver, a transmitter, and/or the like.

Apparatus 902 may include additional components that perform each of the blocks of the algorithm in the aforementioned process 800 of FIG. 8 and/or the like. Each block in the aforementioned process 800 of FIG. 8 and/or the like may be performed by a component, and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of components (e.g., one or more components) shown in FIG. 9 may perform one or more functions described as being performed by another set of components shown in FIG. 9.

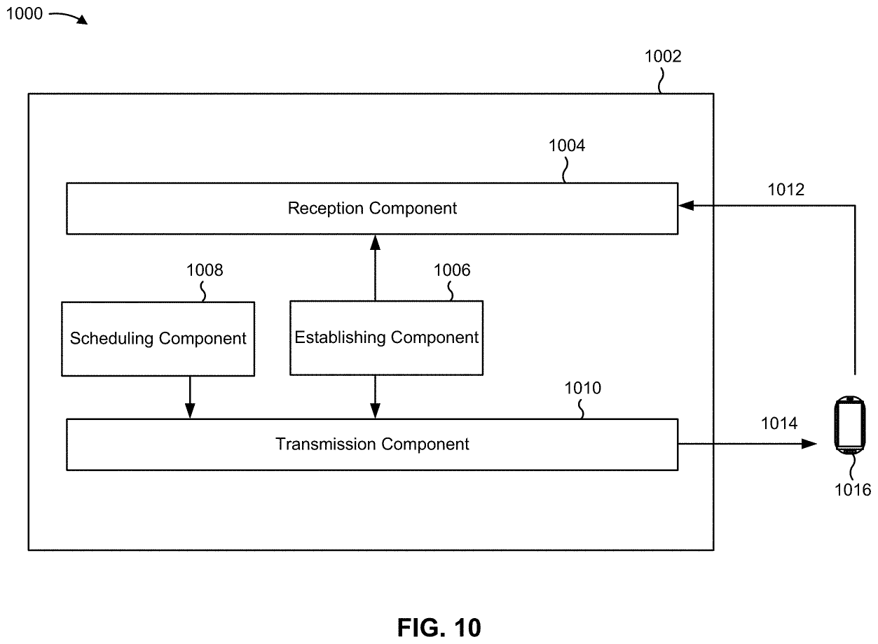

FIG. 10 is a conceptual data flow diagram 1000 illustrating the data flow between different modules/means/components in an example apparatus 1002. The apparatus 1002 may be a base station (e.g., BS 110). In some aspects, apparatus 1002 includes a reception component 1004, an establishing component 1006, a scheduling component 1008, and a transmission component 1010.

Reception component 1004 may receive a communication 1012 from UE 1016. For example, reception component 1004 may receive communication 1012 to establish a single access link with UE 1016, a plurality of access links with UE 1016, and/or the like. In some aspects, reception component 1004 may receive communication 1012, which may identify a pattern for time durations for transmitting to UE 1016 on one of a plurality of access links that UE 1016 has established. In some aspects, reception component 1004 may include an antenna (e.g., antenna 234), a receive processor (e.g., receive processor 238), a controller/processor (e.g., controller/processor 240), a transceiver, a receiver, and/or the like.

Establishing component 1006 may establish access links with UE 1016. For example, establishing component 1006 may communicate with transmission component 1010 to establish a downlink access link, reception component 1004 to establish an uplink access link, and/or the like. In some aspects, establishing component 1006 may include a processor (e.g., a transmit processor 220, a receive processor 238, a controller/processor 240, and/or the like).

Scheduling component 1008 may identify one or more time durations for communicating with UE 1016 on an access link of a plurality of access links that UE 1016 has established. For example, scheduling component 1008 may identify a pattern with which to tune to an access link to receive signaling and/or data, to transmit signaling and/or data, and/or the like. In some aspects, scheduling component 1008 may include a processor (e.g., a transmit processor 220, a receive processor 238, a controller/processor 240, and/or the like).

Transmission component 1010 may transmit a communication 1014 to UE 1016. For example, transmission component 1010 may transmit communication 1014 using a first access link established with UE 1016, a second access link established with UE 1016, and/or the like during a time duration for communicating using an access link established with UE 1016. In some aspects, transmission component 1010 may include an antenna (e.g., antenna 234), a transmit processor (e.g., transmit processor 220), a controller/processor (e.g., controller/processor 240), a transceiver, a transmitter, and/or the like.

Apparatus 1002 may include additional components that perform each of the blocks of the algorithm in the aforementioned process 800 of FIG. 8 and/or the like. Each block in the aforementioned process 800 of FIG. 8 and/or the like may be performed by a component, and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of components (e.g., one or more components) shown in FIG. 10 may perform one or more functions described as being performed by another set of components shown in FIG. 10.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
establishing a first access link associated with a first subscriber identification module (SIM) of the UE;
establishing a second access link associated with a second SIM of the UE;
identifying a set of time durations during which to use the second access link;
transmitting an indication of the set of time durations to a base station; and
tuning to the second access link to communicate with the base station during at least one of the set of time durations.

2. The method of claim 1, wherein the indication of the set of time durations includes information identifying a pattern of the set of time durations.

3. The method of claim 2, wherein the pattern is a periodic pattern.

4. The method of claim 2, wherein the pattern is an aperiodic pattern.

5. The method of claim 2, wherein the pattern is a semi-persistent pattern.

6. The method of claim 2, wherein the pattern is controlled via at least one of media access control signaling, physical layer signaling, or radio resource control signaling.

7. The method of claim 6, wherein the radio resource control signaling may be in-device coexistence indication signaling.

8. The method of claim 1, wherein the indication of the set of time durations is a request for configuration of the set of time durations, and
wherein the set of time durations are configured by at least one of a master node, a secondary node, or a combination thereof.

9. The method of claim 1, wherein tuning to the second access link further comprises:
receiving data or control information from the base station.

10. The method of claim 1, wherein tuning to the second access link further comprises:
transmitting data or control information to the base station.

11. The method of claim 1, wherein the indication of the set of time durations includes an index value identifying the set of time durations.

12. The method of claim 1, wherein the set of time durations is configured to start based at least in part on received signaling, and wherein the received signaling is at least one of radio resource control signaling, media access control layer signaling, or physical layer signaling.

13. The method of claim 1, further comprising:
transmitting signaling to request an end to the set of time durations; and
tuning to the first access link to communicate with the base station after ending the set of time durations.

14. The method of claim 13, wherein transmitting the signaling to request the end to the set of time durations comprises:
starting a voice call or a data communication; and
transmitting the signaling to request the end to the set of time durations based at least in part on starting the voice call or the data communication.

15. The method of claim 1, further comprising:
transmitting signaling to request a change to the set of time durations; and
communicating using at least one of the first access link or the second access link after changing the set of time durations.

16. The method of claim 15, wherein the signaling to request the change to the set of time durations is at least one of radio resource control signaling identifying a different set of time durations or media access control layer signaling identifying an index of the different set of time durations.

17. The method of claim 1, wherein the set of time durations is for at least one of a downlink, an uplink, or a combination of the downlink and the uplink.

18. The method of claim 1, wherein tuning to the second access link comprises:
reducing a communication capability on the first access link from a preconfigured communication capability; and
communicating on the first access link in accordance with the reduced communication capability.

19. The method of claim 18, wherein the reduced communication capability is based at least in part on at least one of a band or radio access technology of: the second access link, the first access link, or a combination of the second access link and the first access link.

20. The method of claim 1, wherein at least one of the first SIM or the second SIM is a universal SIM (USIM).

21. A user equipment (UE) for wireless communication, comprising:
a memory; and
one or more processors operatively coupled to the memory, the memory and the one or more processors configured to:
establish a first access link associated with a first subscriber identification module (SIM) of the UE;
establish a second access link associated with a second SIM of the UE;
identify a set of time durations during which to use the second access link;
transmit an indication of the set of time durations to a base station; and
tun to the second access link to communicate with the base station during at least one of the set of time durations.

22. The UE of claim 21, wherein the indication of the set of time durations includes information identifying a pattern of the set of time durations.

23. The UE of claim 22, wherein the pattern is a periodic pattern.

24. The UE of claim 22, wherein the pattern is an aperiodic pattern.

25. A non-transitory computer-readable medium storing one or more instructions for wireless communication, the one or more instructions comprising:
one or more instructions that, when executed by one or more processors of a user equipment (UE), cause the one or more processors to:
establish a first access link associated with a first subscriber identification module (SIM) of the UE;
establish a second access link associated with a second SIM of the UE;
identify a set of time durations during which to use the second access link;
transmit an indication of the set of time durations to a base station; and
tun to the second access link to communicate with the base station during at least one of the set of time durations.

26. The non-transitory computer-readable medium of claim 25, wherein the indication of the set of time durations includes information identifying a pattern of the set of time durations.

27. The non-transitory computer-readable medium of claim 26, wherein the pattern is a periodic pattern.

28. The non-transitory computer-readable medium of claim 26, wherein the pattern is an aperiodic pattern.

29. An apparatus for wireless communication, comprising:
means for establishing a first access link associated with a first subscriber identification module (SIM) of the apparatus;
means for establishing a second access link associated with a second SIM of the apparatus;
means for identifying a set of time durations during which to use the second access link;
means for transmitting an indication of the set of time durations to a base station; and
means for tuning to the second access link to communicate with the base station during at least one of the set of time durations.

30. The apparatus of claim 29, wherein the indication of the set of time durations includes information identifying a pattern of the set of time durations.
